(19) United States
(12) Patent Application Publication
(10) Pub. No.: US 2014/0288740 A1
(43) Pub. Date: Sep. 25, 2014

(54) CONTROL APPARATUS FOR HYBRID VEHICLE

(71) Applicants: Daisuke ITOYAMA, Toyota-shi (JP); Hideaki YAGUCHI, Toyota-shi (JP); Koji HOKOI, Toyota-shi (JP); Kenji OONISHI, Toyota-shi (JP); Hiroki ENDO, Nissin-shi (JP); Kazuma AOKI, Toyota-shi (JP); Mikihisa ARAI, Toyota-shi (JP)

(72) Inventors: Daisuke ITOYAMA, Toyota-shi (JP); Hideaki YAGUCHI, Toyota-shi (JP); Koji HOKOI, Toyota-shi (JP); Kenji OONISHI, Toyota-shi (JP); Hiroki ENDO, Nissin-shi (JP); Kazuma AOKI, Toyota-shi (JP); Mikihisa ARAI, Toyota-shi (JP)

(73) Assignee: TOYOTA JIDOSHA KABUSHIKI KAISHA, Toyota-shi (JP)

(21) Appl. No.: 14/219,341

(22) Filed: Mar. 19, 2014

(30) Foreign Application Priority Data
Mar. 21, 2013 (JP) 2013-057487

(51) Int. Cl. B60W 20/00; B60W 10/30; B60W 10/06

(52) U.S. Cl. CPC B60W 20/00; B60W 10/06; B60W 10/30; Y10S 903/93
USPC 701/22; 180/65.265; 903/930

(57) ABSTRACT

A control apparatus for a hybrid vehicle includes an engine for traveling, a motor for traveling, and a battery exchanging electric power with the motor. the control apparatus including: a heater is configured to perform heating inside a cabin of the hybrid vehicle by using the engine or an electric heat source as a heat source; and a controller is configured to operate the engine intermittently, the controller is configured to select the heat source for the heater, the controller is configured to determine whether or not a fuel for the engine is degraded when the engine is stopped, and the controller is configured to start the engine and select the engine as the heat source when the controller determines that the fuel is degraded.

### INCORPORATION BY REFERENCE

The disclosure of Japanese Patent Application No. 2013-057487 filed on Mar. 21, 2013 including the specification, drawings and abstract is incorporated herein by reference in its entirety.

### BACKGROUND OF THE INVENTION

1. Field of the Invention

The invention relates to a control apparatus for a hybrid vehicle (HV), and more particularly to a control apparatus for a HV which includes an engine and a motor for traveling, a battery exchanging electric power with the motor, and a heater for heating the interior of the vehicle cabin by using the engine or an electric heat source as a heat source, and which runs with intermittent engine operation.

2. Description of Related Art

A control apparatus has been suggested for a HV that has as drive sources an internal combustion engine, to which fuel stored in a fuel tank is supplied, and an electric motor, to which electric power stored in a battery is supplied, the control apparatus storing history of each refueling time and each refueling amount for a plurality of fuel tank refueling operations and calculates the degree of degradation of the fuel in the fuel tank on the basis of the history (see, for example, Japanese Patent Application Publication No. 2009-255680 (JP 2009-255680A)).

### SUMMARY OF THE INVENTION

When a HV provided with a charger capable of charging a battery with electric power from an external power source is driven only short distances (short-distance running and battery charging are repeated), the fuel in the fuel tank is not consumed for a comparatively long period and the fuel can degrade.

The control apparatus for a HV in accordance with the invention enhances the consumption of the degraded fuel.

According to an aspect of the invention, a control apparatus for a HV including an engine for traveling, a motor for traveling, and a battery exchanging electric power with the motor. The control apparatus includes a heater configured to perform heating inside a cabin of the HV by using the engine or an electric heat source as a heat source, and a controller configured to drive the engine intermittently. The controller is configured to select the heat source for the heater. The controller is configured to determine whether or not a fuel for the engine is degraded when the engine is stopped, and the controller is configured to start the engine and select the engine as the heat source when the controller determines that the fuel is degraded.

In the control apparatus for a HV according to the aspect of the invention, when the controller determines that the fuel for the engine is degraded, the controller starts the engine and selects the engine as the heat source of the heater. As a result, the consumption of the degraded fuel can be enhanced. In this case, the HV can be also provided with a charger capable of charging the battery by using electric power from an external electric power source.

Further, in the control apparatus for a HV according to the aspect of the invention, when the controller determines that the fuel is degraded and the heater heats the cabin, the controller may extend a warm-up time of the engine longer in comparison with a case when the controller determines that the fuel is not degraded and the heater heats the cabin. Further, when the controller determines that the fuel for the engine is degraded and the heater heats the cabin, the controller may increase a revolution speed of the engine during warm-up higher in comparison with a case when the controller determines that the fuel is not degraded and the heater heats the cabin. In such cases, it is possible to enhance further the consumption of the degraded fuel and improve heating performance of the heater.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration diagram illustrating schematically the configuration of a HV of an embodiment of the invention;

FIG. 2 is a flowchart illustrating an example of a processing routine executed by a HV electronic control unit (ECU) of the embodiment when fuel has degraded;

FIG. 3 is a configuration diagram illustrating schematically the configuration of a HV 120 of a variation example;

FIG. 4 is a configuration diagram illustrating schematically the configuration of a HV 220 of a variation example; and

FIG. 5 is a configuration diagram illustrating schematically the configuration of a HV 320 of a variation example.

### DETAILED DESCRIPTION OF EMBODIMENTS

A mode for carrying out the invention is explained below on the basis of an embodiment thereof.

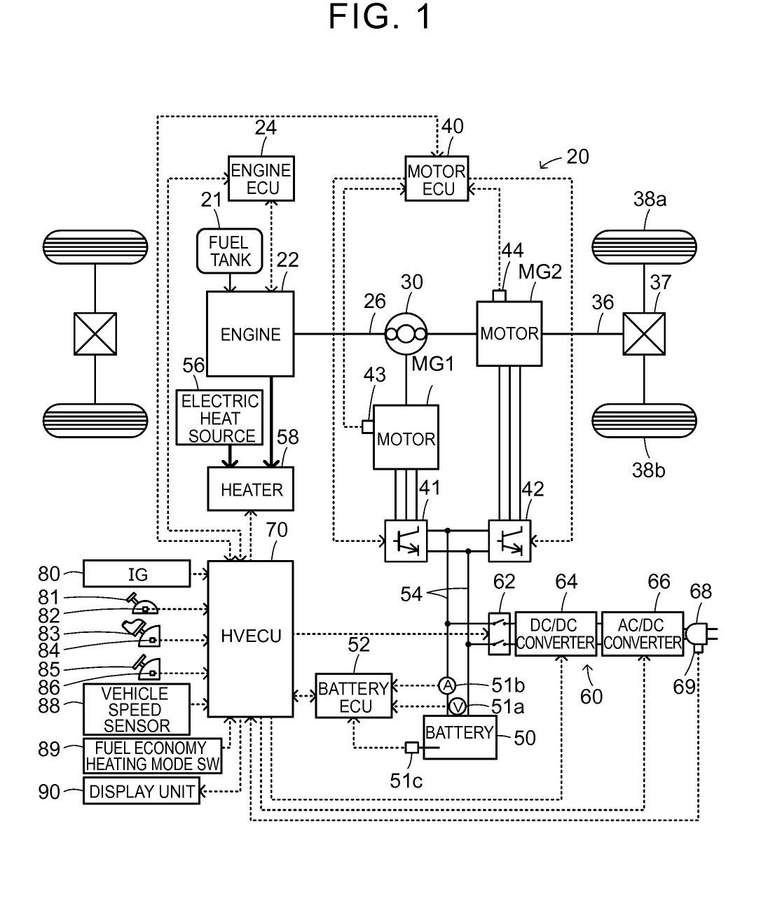

FIG. 1 is a configuration diagram illustrating schematically the configuration of a HV 20 as an embodiment of the invention. As shown in the figure, the HV 20 according to the embodiment is provided with an engine 22 that receives the supply of fuel such as gasoline or light oil from a fuel tank 21 and outputs power; an engine ECU 24 that performs drive control of the engine 22; a planetary gear 30 in which a carrier is connected to a crankshaft 26 of the engine 22; and a ring gear is connected to a drive axle 36 linked by a differential gear 37 to drive wheels 38a, 38b; a motor MG1 constituted, for example, as a synchronous motor generator and connected by a rotor to a sun gear of the planetary gear 30; a motor MG2 constituted, for example, as a synchronous motor generator and connected by a rotor to the drive axle 36; inverters 41, 42 for driving the motors MG1, MG2; a motor ECU 40 that performs drive control of the motors MG1, MG2 by switch controlling switching elements (not shown in the figure) of the inverters 41, 42; a battery 50 that is configured, for example, as a lithium ion secondary battery and that exchanges electric power with the motors MG1, MG2 via the inverters 41, 42; a battery ECU 52 that manages the battery 50; a heater 58 that performs heating inside a HV cabin by using as a heat source the engine 22 or an electric heat source (for example, a heat pump or an electric heater) 56; a charger 60 that is connected to an external power source such as a household power source and can charge the battery 50; and a hybrid ECU (referred to hereinbelow as HVECU) 70 that controls the entire vehicle.

The engine ECU 24 is configured as a microprocessor centered on a central processing unit (CPU) (this configuration is not shown in the figure), and is provided, in addition to the CPU, with a read only memory (ROM) that stores a processing program, a random access memory (RAM) for temporarily storing data, input/output ports, and a communication port (this configuration is not shown in the figure). Signals from various sensors detecting the drive state of the engine 22 are inputted via the input port into the engine ECU 24. Examples of the signals include a crank position θcr from a crank position sensor that detects the rotation position of the crankshaft 26; a cooling water temperature Tw from a water temperature sensor that detects the temperature of cooling water in the engine 22; a pressure Pin inside a cylinder from a pressure sensor attached inside a combustion chamber; a cam position θca from a cam position sensor that detects the rotation position of a camshaft that opens and closes an intake valve and an exhaust valve that perform intake and exhaust to and from the combustion chamber; a throttle position TP from a throttle position sensor that detects the position of a throttle valve; an intake air amount Qa from an air flow meter mounted on an intake pipe; an intake temperature Ta from a temperature sensor also mounted on the intake pipe; an air-fuel ratio AF from an air-fuel sensor mounted on an exhaust system; and an oxygen signal O2 from an oxygen sensor also mounted on the exhaust system. A variety of control signals for driving the engine 22 are outputted from the engine ECU 24 via the output port. Examples of such signals include a drive signal to fuel injection valves, a drive signal to a throttle motor that adjusts the throttle valve position; a control signal to an ignition coil integrated with an igniter, and a control signal to a variable valve timing mechanism that can change the opening-closing timing of the intake valve. Further, the engine ECU 24 communicates with the HVECU 70 and performs drive control of the engine 22 by a control signal from the HVECU 70. The engine ECU 24 also outputs, as necessary, data relating to the drive state of the engine 22 to the HVECU 70. The engine ECU 24 also calculates the revolution speed of the crankshaft 26, that is, the revolution speed Ne of the engine 22, on the basis of a signal from the crank position sensor (not shown in the figure) mounted on the crankshaft 26.

The motor ECU 40 is configured as a microprocessor centered on a CPU (this configuration is not shown in the figure) and is provided, in addition to the CPU, with a ROM that stores a processing program, a RAM for temporarily storing data, input/output ports, and a communication port. Signals necessary for performing drive control of the motors MG1, MG2 are inputted via the input port into the motor ECU 40. Examples of such signals include revolution positions θm1, θm2 from the revolution position detection sensors 43, 44 that detect the revolution positions of the rotors of the motors MG1, MG2, and phase currents applied to the motors MG1, MG2, which are detected by current sensors (not shown in the figure). Switching control signals to the switching elements (not shown in the figure) of the inverters 41, 42 are outputted via the output port from the motor ECU 40. The motor ECU 40 also communicates with the HVECU 70, performs drive control of the motors MG1, MG2 by the control signals from the HVECU 70. The motor ECU 40 also outputs, as necessary, data relating to the drive state of the motors MG1, MG2 to the HVECU 70. The motor ECU 40 also calculates the revolution angle speed ωm1, ωm2 and revolution speed Nm1, Nm2 of the motors MG1, MG2 on the basis of the revolution positions θm1, θm2 of the motors MG1, MG2 from the revolution position detection sensors 43, 44.

The battery ECU 52 is configured as a microprocessor centered on a CPU (this configuration is not shown in the figure) and is provided, in addition to the CPU, with a ROM that stores a processing program, a RAM for temporarily storing data, input/output ports, and a communication port. Signals necessary for managing the battery 50 are inputted into the battery ECU 52. Examples of such signals include a terminal voltage Vb from a voltage sensor 51a disposed between the terminals of the battery 50, a charge-discharge current Ib from a current sensor 51b mounted on an electric power line connected to the output terminals of the battery 50, and a battery temperature Tb from a temperature sensor 51c mounted on the battery 50. The battery ECU 52 transmits, as necessary, data relating to the state of the battery 50 by communication to the HVECU 70. In order to manage the battery 50, the battery ECU 52 calculates an electric power storage ratio SOC, which is a ratio of the capacity of the electric power dischargeable from the battery 50 at this time to the total capacity on the basis of the integral value of the charge-discharge current Ib detected by the current sensor 51b. The battery ECU 52 also calculates the input and output limits Win, Wout, which are allowable input and output electric power that may be charged into and discharged from the battery 50 on the basis of the calculated electric power storage ratio SOC and the battery temperature Tb. The input and output limits Win, Wout of the battery 50 can be set by setting the basic values of the input and output limits Win, Wout on the basis of the battery temperature Tb, setting an output limit correction factor and an input limit correction factor on the basis of the electric power storage ratio SOC of the battery 50, and multiplying the basic values of the input and output limits Win, Wout, which have been set, by the input limit correction factor and an output limit correction factor, respectively.

The heater 58 is provided with a heat exchanger that warms the air by using cooling water of the engine 22 or the electric heat source 56 as a heat source, and a blower that blows the air warmed up by the heat exchanger into the HV cabin (this configuration is not shown in the figure).

The charger 60 is connected via a relay 62 to an electric power line 54 connecting the inverters 41, 42 with the battery 50. The charger 60 is provided with an AC/DC converter 66 that converts AC power from an external electric power source that is supplied via an electric power supply plug 68 into DC power, and a DC/DC converter 64 that converts the voltage of the DC power from the AC/DC converter 66 and supplies the converted voltage to the electric power line 54.

The HVECU 70 is configured as a microprocessor centered on a CPU (this configuration is not shown in the figure) and is provided, in addition to the CPU, with a ROM that stores a processing program, a RAM for temporarily storing data, input/output ports, and a communication port. The following signals are inputted into the HVECU 70 via the input port: a connection detection signal from a connection detection sensor 69 that detects the connection of the electric power supply plug 68 to the external electric power supply, an ignition signal from an ignition switch 80, a shift position SP from a shift position sensor 82 that detects the operation position of a shift lever 81, an accelerator depression amount Acc from an accelerator pedal position sensor 84 that detects the depression amount of an accelerator pedal 83, a brake pedal position BP from a brake pedal position sensor 86 that detects the depression amount of a brake pedal 85, a vehicle speed V from a vehicle speed sensor 88, and an ON/OFF signal from a fuel economy heating mode switch 89 that allows the user to indicate a fuel economy heating mode in which heating is forcibly performed with the heater 58 using the engine 22 as a heat source. The HVECU 70 outputs, via the output port, a control signal to the electric heat source 56, a control signal to the heater 58, and a display signal to the display unit 90 that displays various types of information. As mentioned hereinabove, the HVECU 70 is connected via the communication port to the engine ECU 24, motor ECU 40, and battery ECU 52 and exchanges various control signals and data with the engine ECU 24, motor ECU 40, and battery ECU 52.

In the HV 20 of the embodiment according to the invention, a required torque Tr* that should be outputted to the drive axle 36 is calculated on the basis of the vehicle speed V and the accelerator depression mount Acc corresponding to the amount of depression of the accelerator pedal by the driver. The drive control of the engine 22 and the motors MG1, MG2 is performed such that the required power corresponding to the required torque Tr* is outputted to the drive axle 36. The drive control of the engine 22 and the motors MG1, MG2 can be performed in a torque conversion drive mode, a charge-discharge drive mode, and a motor drive mode. <Torque conversion drive mode> In this drive mode, the drive control of the engine 22 is performed such that the mechanical power matching the required power is outputted from the engine 22, and the drive control of the motor MG1 and the motor MG2 is performed such that the entire mechanical power outputted from the engine 22 is subjected to torque conversion by the planetary gear 30, the motor MG1, and the motor MG2, and the torque-converted power is outputted to the drive axle 36. <Charge-discharge drive mode> In this drive mode, the drive control of the engine 22 is performed such that the mechanical power matching a sum of the required power and the electric power necessary for charging and discharging the battery 50 is outputted from the engine 22. Further, the drive control of the motor MG1 and the motor MG2 is performed such that the required power is outputted to the drive axle 36 as the battery 50 is charged and discharged and also as the entire mechanical power outputted from the engine 22 or part of the outputted mechanical power is subjected to torque conversion by the planetary gear 30, the motor MG1, and the motor MG2. <Motor drive mode> The drive control is performed such that the drive of the engine 22 is stopped and the power matching the required power from the motor MG2 is outputted to the drive axle 36. Further, both in the torque conversion drive mode and in the charge-discharge drive mode, the engine 22, the motor MG1, and the motor MG2 are controlled such that the required power is outputted to the drive axle 36 as the engine 22 is driven, and the two control modes are not substantially different from each other. Accordingly, the two modes will be together referred to hereinbelow as an engine drive mode.

In the engine drive mode, the HVECU 70 sets the required torque Tr* which is required for traveling (should be outputted to the drive axle 36) on the basis of the accelerator depression amount Acc from the accelerator pedal position sensor 84 and the vehicle speed V from the vehicle speed sensor 88. Traveling power Pdrv*, which is required for traveling, is then calculated by multiplying the required torque Tr*, which has been set, by the revolution speed Nr (for example, a revolution speed Nm2 of the motor MG2 or the revolution speed obtained by multiplying the vehicle speed V by a recalculation factor) of the drive axle 36. Required power Pe*, which is required for the vehicle (should be outputted from the engine 22) is then set by subtracting charge-discharge required power Pb* (a positive value when the battery 50 is discharged) of the battery 50, which is based on the power storage ratio SOC of the battery 50, from the calculated traveling power Pdrv*. A target revolution speed Ne* and a target torque Te* of the engine 22 are then set by using an operation line (for example, a fuel economy optimum operation line) as a relationship between the revolution speed Ne and torque Te of the engine 22 at which the required power Pe* can be efficiently outputted from the engine 22. A drive point constituted by the target revolution speed Ne* and target torque Te* based on the required power Pe* and operation line is referred to hereinbelow as a fuel economy drive point. A torque command Tm1*of the motor MG1 is then set by revolution speed feedback control such that the revolution speed Ne of the engine 22 becomes the target revolution speed Ne* within the range of the input/output limits Win, Wout of the battery 50. Also, a torque command Tm2* of the motor MG2 is set by subtracting a torque acting upon the drive axle 36 via the planetary gear 30 when the motor MG1 is driven according to the torque command Tm1* from the required torque Tr*. The target revolution speed Ne* and target torque Te*, which have been set, are transmitted to the engine ECU 24, and the torque commands Tm1,*, Tm2* are transmitted to the motor ECU 40. The engine ECU 24 that has received the target revolution speed Ne* and target torque Te* performs the intake air amount control, fuel injection control, and ignition control of the engine 22 such that the engine 22 is driven at the target revolution speed Ne* and target torque Te*. The motor ECU 40 that has received the torque commands Tm1*, Tm2* performs switching control of the switching elements of the inverters 41, 42 such that the motors MG1, MG2 are driven according to the torque commands Tm1*, Tm2*. Because of such control, the required torque Tr* can be outputted to the drive axle 36 to run the vehicle within the range of input/output limits Win, Wout of the battery 50, while the engine 22 is driven with good efficiency. In the engine drive mode, when the stopping condition of the engine 22, such as the condition of the required power Pe* of the engine 22 getting equal to or lower than a stop threshold Pstop, is fulfilled the drive of the engine 22 is stopped and a transition is made to the motor drive mode. The stop threshold Pstop is set as the upper limit of the range of the required power Pe* in which it is better to stop the drive of the engine 22.

In the motor drive mode, the HVECU 70 sets the required torque Tr* on the basis of the accelerator depression amount Acc and vehicle speed V and sets a value 0 for the torque command Tm1* of the motor MG1. Further, the torque command Tm2* of the motor MG2 is set such that the required torque Tr* is outputted to the drive axle 36 within the range of input/output limits Win, Wout of the battery 50, and the torque command that has been set is transmitted to the motor ECU 40. The motor ECU 40 that has received the torque commands Tm1*, Tm2* performs switching control of the switching elements of the inverters 41, 42 such that the motors MG1, MG2 are driven according to the torque commands Tm1*, Tm2*. Because of such control, the required torque Tr* can be outputted to the drive axle 36 to run the vehicle within the range of input/output limits Win, Wout of the battery 50 in a state in which the drive of the engine 22 is stopped. In such a motor drive mode, the required power Pe* of the engine 22 is calculated that is obtained by subtracting the charge-discharge required power Pb* of the battery 50 from the traveling power Prdrv* obtained by multiplying the required torque Tr* by the revolution speed Nr of the drive axle 36. Further, the condition of the required power Pe* getting equal to or higher than a start threshold Pstart, which has been set as the lower limit of the range of the required power Pe* in which it is better to start the engine 22, is established as the starting condition for the engine 22. When such starting condition for the engine 22 is fulfilled, the engine 22 is started and a transition is made to the engine drive mode.

In the HV 20 of the embodiment of the invention, where an actuation request signal is received from the heater 58, heating inside the HV cabin is performed using the engine 22 or the electric heat source 56 as a heat source. In the embodiment, when the engine 22 is driven, a revolution speed Neh1 (for example, 1200 rpm or 1300 rpm) that has been set to check the heating performance of the heater 58 when the engine 22 is used as a heat source is set as a heating target revolution speed Neh of the engine 22. In this case, the engine 22 is driven when the HV travels in the engine drive mode or when the HV travels using power from the motor MG2 while the engine 22 is warmed up (autonomous drive). The engine 22 is controlled such that the engine 22 is driven at a revolution speed equal to or higher than the heating target revolution speed Neh. Thus, when the HV travels in the engine drive mode, the engine 22 is driven at the fuel economy drive point or a drive point that has shifted from the fuel economy drive point. When the engine 22 is warmed up, the engine 22 is warmed up (autonomous drive) at the heating target revolution speed Neh. When the HV travels while the engine 22 is being warmed up, a temperature Twend1 (for example, 40° C. or 50° C.) is set as a warm-up end water temperature Twend. It is assumed that when the cooling water temperature Tw of the engine 22 becomes equal to or higher than the warm-up end water temperature Twend, the engine 22 is stopped and a transition is made to the motor drive mode. When the HV travels in the motor drive mode, the electric heat source 56 is controlled to check the heating performance of the heater 58 using the electric heat source 56 as a heat source.

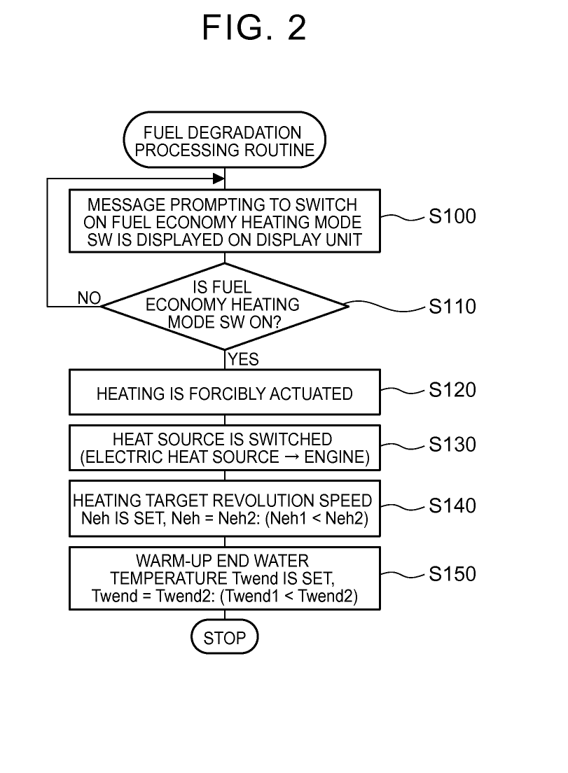

The operation of the HV 20 of the embodiment according to the invention, in particular the control of the heater 58 performed when the fuel for the engine 22 has degraded is explained below. FIG. 2 is a flowchart illustrating an example of a processing routine executed by the HVECU 70 of the embodiment when the fuel has degraded. This routine is executed when HVECU 70 determines that the fuel for the engine 22 is degraded when the engine 22 is stopped. Whether or not the fuel for the engine 22 has degraded can be determined, for example, on the basis of whether or not a predetermined period of time (for example, several months to about one year) has passed since the previous refueling. In the HV 20 of the embodiment, the battery 50 can be charged using electric power from an external electric power source such as a household electric power source. Therefore, when the HV is driven only short distances within the range of the electric power charged to the battery 50 (short-distance running and charging of the battery 50 are repeated), the fuel in the fuel tank 21 is not consumed for a comparatively long period and the fuel can degrade. Such a state is assumed in the embodiment.

Where the fuel degradation processing routine is executed, the HVECU 70 initially displays on the display unit 90 a message prompting to switch on the fuel economy heating mode switch 89 (step S100), and waits till the user switches on the fuel economy heating mode switch 89 (step S110).

Where the fuel economy heating mode switch 89 is switched on by the user, it is determined to actuate forcibly the heating with the heater 58 (step S120) and the engine 22 is started, thereby switching (selecting) the heat source of the heater 58 from the electric heat source 56 to the engine 22 (step S130). As a result, the consumption of the fuel (degraded fuel) in the fuel tank 21 can be enhanced. Further, the consumption of electric power from the battery 50 on the heating with the heater 58 can be inhibited.

Then, a revolution speed Neh2, for degraded fuel, (for example, 1500 rpm or 1600 rpm) that is higher than the aforementioned revolution speed Neh1, for undegraded fuel, (for example, 1200 rpm or 1300 rpm) is set (step S140) as the heating target revolution speed Neh of the engine 22 and a temperature Twend2 (for example, 70° C. or 80° C.) that is higher than the aforementioned temperature Twend1 (for example, 40° C. or 50° C.) is set (step S150) as the warm-up end water temperature Twend, thereby ending the routine. The increase in the warm-up end water temperature Twend (setting the temperature Twend2 for degraded fuel which is higher than the temperature Twend1 for undegraded fuel) means that the warm-up time of the engine 22 is extended.

Where the heating target revolution speed Neh and the warm-up end water temperature Twend of the engine 22 are thus set, when the cooling water temperature Tw of the engine 22 is lower than the warm-up end water temperature Twend, the engine 22 is warmed up (autonomously driven) at the heating target revolution speed Neh. When the cooling water temperature Tw of the engine 22 is equal to or higher than the warm-up end water temperature Twend, the engine 22 is controlled such that the engine 22 is stopped. As a result, heating with the heater 58 is forcibly performed by using the cooling water of the engine 22 as a heat source. When the engine 22 is warmed up, the revolution speed Ne of the engine 22 is increased (to the revolution speed Neh2 for degraded fuel which is higher than the revolution speed Neh1 for undegraded fuel), the warm-up end water temperature Twend of the engine 22 is increased (to the temperature Twend2 for degraded which is higher than the temperature Twend1 for undegraded) and the warm-up time is extended, thereby making it possible to enhance further the consumption of the fuel (degraded fuel) in the fuel tank 21 and increase the heating performance of the heater 58.

With the HV 20 of the above-described embodiment of the invention, where the degradation of the fuel for the engine 22 is detected when the drive of the engine 22 is stopped, the engine 22 is started and the heat source of the heater 58 is switched from the electric heat source 56 to the engine 22. Therefore, the consumption of the fuel (degraded fuel) in the fuel tank 21 can be enhanced. Furthermore, when the fuel for the engine 22 is degraded, the revolution speed Neh2 and the temperature Twend2, which are higher than the revolution speed Neh1 and the temperature Twend1 that are set when the fuel for the engine 22 is not degraded, are set as the heating target revolution speed Neh and warm-up end water temperature Twend of the engine 22, and the control is performed such that the engine 22 is warmed up at the heating target revolution speed Neh till the cooling water temperature Tw of the engine 22 becomes equal to or higher than the warm-up end water temperature Twend. As a result, it is possible to enhance further the consumption of the fuel (degraded fuel) in the fuel tank 21 and increase the heating performance of the heater 58.

Further, in the HV 20 of the above-described embodiment of the invention, when the fuel for the engine 22 has degraded, the revolution speed Neh2 and temperature Twend2, which are higher than the revolution speed Neh1 and temperature Twend 1 that are set when the fuel for the engine 22 is not degraded, are set as the heating target revolution speed Neh and warm-up end water temperature Twend of the engine 22. Alternatively, the revolution speed Neh2, which is higher than the revolution speed Neh1 that is set when the fuel for the engine 22 is not degraded, may be set as the heating target revolution speed Neh of the engine 22, but the temperature Twend1 equal to that set when the fuel for the engine 22 is not degraded may be set as the warm-up end water temperature Twend. Further, the temperature Twend2, which is higher than the temperature Twend1 that is set when the fuel for the engine 22 is not degraded, may be set at the warm-up end water temperature Twend of the engine 22, but the revolution speed Neh1 equal to that set when the fuel for the engine 22 is not degraded may be set as the heating target revolution speed Neh of the engine 22.

In the HV 20 of the above-described embodiment, where it is determined that the fuel for the engine 22 has degraded when the engine 22 is stopped, the engine 22 is started, thereby switching the heat source of the heater 58 from the electric heat source 56 to the engine 22, and the revolution speed Neh2 and temperature Twend2, which are higher than the revolution speed Neh1 and temperature Twend1 that are set when the fuel for the engine 22 is not degraded, are set as the heating target revolution speed Neh and warm-up end water temperature Twend of the engine 22. Alternatively, the heat source of the heater 58 may be switched from the electric heat source 56 to the engine 22 to cause forcible heating. For example, the revolution speed Neh1 and temperature Twend1 equal to those set when the fuel for the engine 22 is not degraded may be set as the heating target revolution speed Neh and warm-up end water temperature Twend of the engine 22.

In the HV 20 of the above-described embodiment, where it is determined that the fuel for the engine 22 has degraded when the engine 22 is stopped, the engine 22 is immediately started, thereby switching the heat source of the heater 58 from the electric heat source 56 to the engine 22. Alternatively, when it is indicated that preheating is to be performed for heating the inside of the HV in advance, that is, before the vehicle runs, after the degradation of the fuel for the engine 22 has been determined, the heat source of the heater 58 may be switched to the engine 22 by starting the engine 22. In this case, the consumption of the fuel (degraded fuel) in the fuel tank 21 can be enhanced when the preheating is executed. In the preheating performed in such a case, the revolution speed Neh2 and temperature Twend2, which are higher than the revolution speed Neh1 and temperature Twend1 that are set when the fuel for the engine 22 is not degraded, may be set as the heating target revolution speed Neh and warm-up end water temperature Twend of the engine 22. Further, the revolution speed Neh2, which is higher than the revolution speed Neh1 that is set when the fuel for the engine 22 is not degraded, may be set as the heating target revolution speed Neh of the engine 22, but the temperature Twend1 same as that set when the fuel for the engine 22 is not degraded may be set as the warm-up end water temperature Twend. Alternatively, the temperature Twend2, which is higher than the temperature Twend1 that is set when the fuel for the engine 22 is not degraded, may be set as the warm-up end water temperature Twend of the engine 22, but the revolution speed Neh1 same as that set when the fuel for the engine 22 is not degraded may be set as the heating target revolution speed Neh of the engine 22. Alternatively, the revolution speed Neh1 and temperature Twend1 same as those set when the fuel for the engine 22 is not degraded may be set as the heating target revolution speed Neh and the warm-up end water temperature Twend of the engine 22.

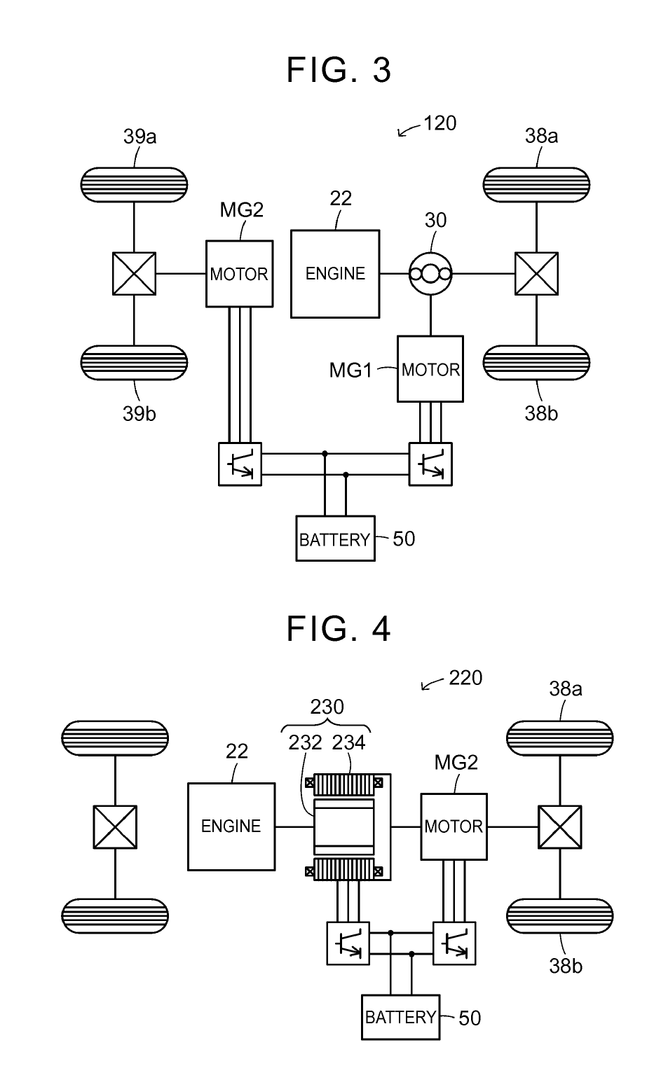

In the HV 20 of the embodiment of the invention, the power from the motor MG2 is outputted to the drive axle 36 connected to the drive wheels 38a, 38b. Alternatively, the power from the motor MG2 may be outputted to an axle (axle connected to wheels 39a, 39b in FIG. 3) other than the axle (axle connected to the drive wheels 38a, 38b) connected to the drive axle 36, as exemplified by a HV 120 of the variation example shown in FIG. 3.

In the HV 20 of the embodiment of the invention, the power from the engine 22 is outputted via the planetary gear 30 to the drive axle 36 connected to the drive wheels 38a, 38b. Alternatively, a twin-rotor electric motor 230 may be provided which has an inner rotor 232 connected to the crankshaft of the engine 22 and an outer rotor 234 connected to the drive axle 36 connected to the drive wheels 38a, 38b and which transfers part of the mechanical power from the engine 22 to the drive axle 36 and converts the remaining mechanical power into electric power, as exemplified by a HV 220 of the variation example shown in FIG. 4.

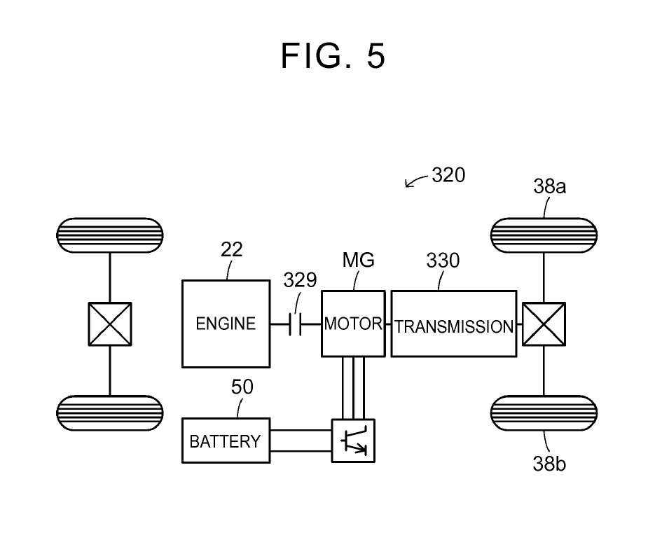

In the HV 20 of the embodiment of the invention, the power from the engine 22 is outputted via the planetary gear 30 to the drive axle 36 connected to the drive wheels 38a, 38b, and the power from the motor MG2 is also outputted to the drive axle 36. Alternatively, the configuration may be used in which a motor MG is attached by a transmission 330 to the drive axle 36 connected to the drive wheels 38a, 38b, and the engine 22 is connected by a clutch 329 to the rotating shaft of the motor MG, as exemplified by a HV 320 of the variation example shown in FIG. 5. With such a configuration, the power from the engine 22 may be outputted to the drive axle 36 via the rotating shaft of the motor MG and the transmission 330, and the power from the motor MG may be outputted to the drive axle via the transmission 330.

The correspondence relationship between the main elements in the embodiment of the invention and the main elements of the invention that are set forth in the claims is explained below. The “engine 22” in the embodiment of the invention corresponds to the “engine” in the claims. The “motor MG2” in the embodiment of the invention corresponds to the “motor” in the claims. The “electric heat source 56” in the embodiment of the invention corresponds to the “electric heat source” in the claims. The “heater 58” in the embodiment of the invention corresponds to the “heater” in the claims. The “HVECU 70” in the embodiment of the invention corresponds to the “controller” in the claims.

The correspondence relationship between the main elements in the embodiment of the invention and the main elements of the invention that are set forth in the claims is merely an example for explaining a specific mode for carrying out the invention described in the claims. Therefore, no limitation is placed on the elements of the invention described in the claims. Thus, the invention described in the claims should be interpreted on the basis of the description thereof, and the embodiment is merely a specific example of the invention described in the claims.

The mode for carrying out the invention is explained hereinabove by using the embodiment, but the invention is obviously not limited to the embodiment and can be implemented in a variety of forms without departing from the essence of the invention.

The invention can be used in manufacturing industry of HVs.

What is claimed is:

1. A control apparatus for a hybrid vehicle including an engine for traveling, a motor for traveling, and a battery exchanging electric power with the motor,
the control apparatus comprising:
a heater configured to perform heating inside a cabin of the hybrid vehicle by using the engine or an electric heat source as a heat source; and
a controller configured to operate the engine intermittently, the controller configured to select the heat source for the heater, the controller being configured to determine whether or not a fuel for the engine is degraded when the engine is stopped, and the controller being configured to start the engine and select the engine as the heat source when the controller determines that the fuel is degraded.

2. The control apparatus for a hybrid vehicle according to claim 1, wherein
the controller is configured to extend, when the controller determines that the fuel is degraded and the heater heats the cabin, a warm-up time of the engine longer in comparison with a case when the controller determines that the fuel is not degraded and the heater heats the cabin.

3. The control apparatus for a hybrid vehicle according to claim 1, wherein
the controller is configured to increase, when the controller determines that the fuel is degraded and the heater heats the cabin, a revolution speed of the engine during warm-up higher in comparison with a case when the controller determines that the fuel is not degraded and the heater heats the cabin.

4. The control apparatus for a hybrid vehicle according to claim 1, wherein:
the controller is configured to extend, when the controller determines that the fuel is degraded and the heater heats the cabin, a warm-up time of the engine longer in comparison with a case when the controller determines that the fuel is not degraded and the heater heats the cabin, and the controller is configured to increase, when the controller determines that the fuel is degraded and the heater heats the cabin, a revolution speed of the engine during warm-up higher in comparison with a case when the controller determines that the fuel is not degraded and the heater heats the cabin.
